(19) United States
(12) Patent Application Publication
(10) Pub. No.: US 2013/0344366 A1
(43) Pub. Date: Dec. 26, 2013

(54) BATTERY COVER ASSEMBLY FOR PORTABLE ELECTRONIC DEVICES

(71) Applicants: FIH (HONG KONG) LIMITED, Kowloon (HK); SHENZHEN FUTAIHONG PRECISION INDUSTRY CO., LTD., Shenzhen (CN)

(72) Inventors: Jing-Hua Liu, Shenzhen (CN); Yong-Gang Zhang, Shenzhen (CN); Kuan-Hung Chen, Shindian (TW)

(21) Appl. No.: 13/914,625

(22) Filed: Jun. 11, 2013

(30) Foreign Application Priority Data
Jun. 21, 2012 (CN) 201210207233X

(51) Int. Cl. H01M 2/10

(52) U.S. Cl. CPC H01M 2/1022
USPC 429/100

(57) ABSTRACT

A battery cover assembly includes a base body, a battery cover and four connecting modules. The base body defines two opposite slots at opposite sides and has a hook at one end. The battery cover has a clasp. The four connecting modules are received in the slots and are rotatably attached to the base body and the battery cover. Each connecting module includes a pivot arm and a torsion spring, the pivot arm having a first end and a second end, the torsion spring fitted around the first end. One end of the pivot arms of the connecting modules is rotatably connected to the base body, and another end of the pivots arm of the connecting modules is rotatably connected to the battery cover, the torsion springs provide force to open the battery cover relative to the base body.

### BACKGROUND

1. Technical Field

The present disclosure generally relates to battery cover assemblies and, particularly, to a battery cover assembly for use in a portable electronic device.

2. Description of related art

Batteries are widely used in portable electronic devices, such as personal digital assistants (PDAs), and mobile phones. Conventional batteries are removably installed in the electronic device, and battery covers are designed to connect to housings of the electronic devices to cover and protect the batteries. Batteries are replaced by opening the battery covers when, for example, the batteries are damaged and/or dead.

Although battery cover assemblies may be simple, engagement between the battery cover and the housing of the mobile phone can be too firm to be easily undone. Additionally, the battery cover can also be easily lost after the battery cover is detached from the housing.

Therefore, there is room for improvement within the art.

### BRIEF DESCRIPTION OF THE DRAWINGS

Many aspects of the battery cover assembly can be better understood with reference to the following drawings. The components in the drawings are not necessarily drawn to scale, the emphasis instead being placed upon clearly illustrating the principles of the battery cover assembly. Moreover, in the drawings, like reference numerals designate corresponding parts throughout the several views.

FIG. 1 is an exploded, isometric view of a portable electronic device employing a battery cover assembly in accordance with an exemplary embodiment.

FIG. 2 is similar to FIG. 1, but only showing the connecting module and the battery cover from another aspect.

FIG. 3 is an enlarged view of the connecting module shown in FIG. 1.

FIG. 4 is an assembly view of the portable electronic device.

FIG. 5 is a schematic view of the portable electronic device showing a partially open state.

FIG. 6 is a schematic view of the portable electronic device showing a complete open state.

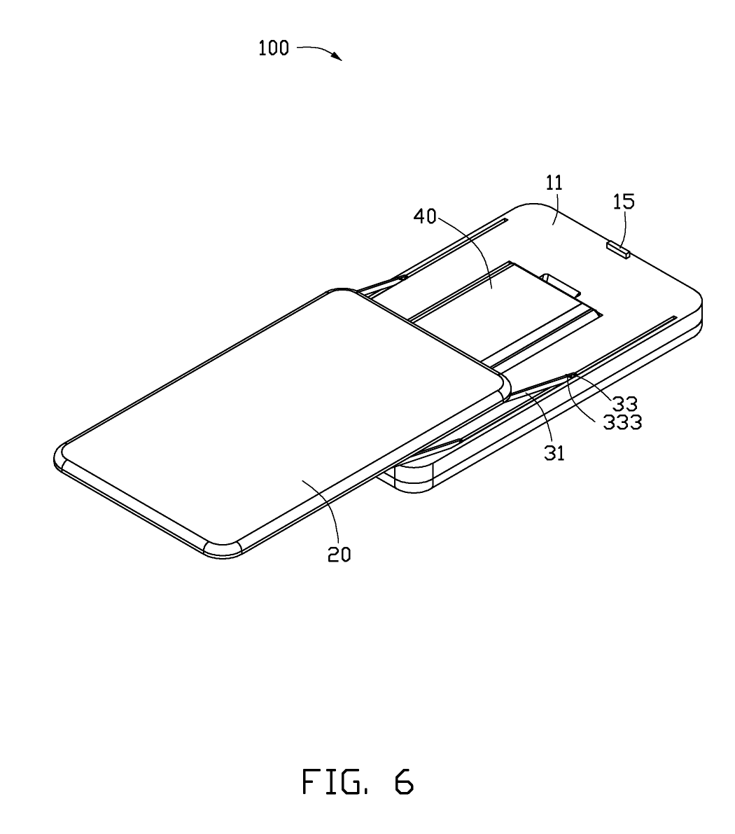

### DETAILED DESCRIPTION

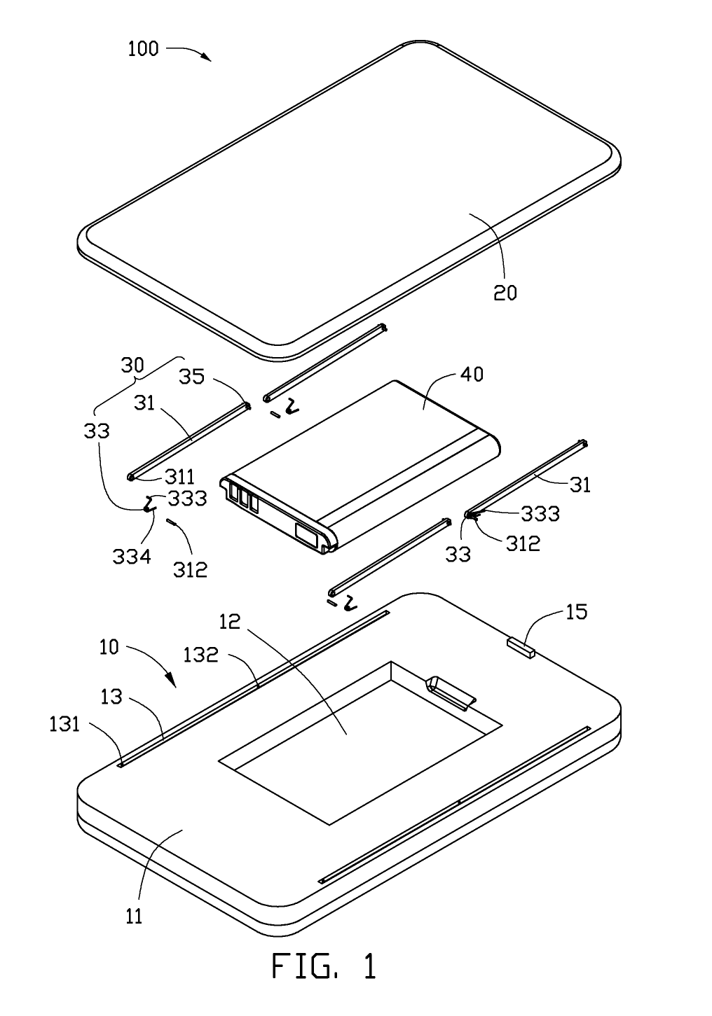

FIG. 1 shows a portable electronic device 100, such as a mobile phone, having a battery cover assembly. The mobile phone 100 is an exemplary embodiment of a battery cover assembly. The battery cover assembly includes a base body 10, a battery cover 20, four connecting modules 30, and a battery 40. The connecting modules 30 rotatably connect the battery cover 20 to the base body 10.

The base body 10 includes a top surface 11. The top surface 11 defines a cavity 12 for receiving the battery 40. One end of the base body 10 has a hook 15 projecting from the top surface 11. Each of opposite sides of the top surface 11 defines a slot 13 for receiving two of the four connecting modules 30. Opposite inner walls of each slot 13 have two shaft holes 131 at one end and two shaft holes 132 at a middle thereof.

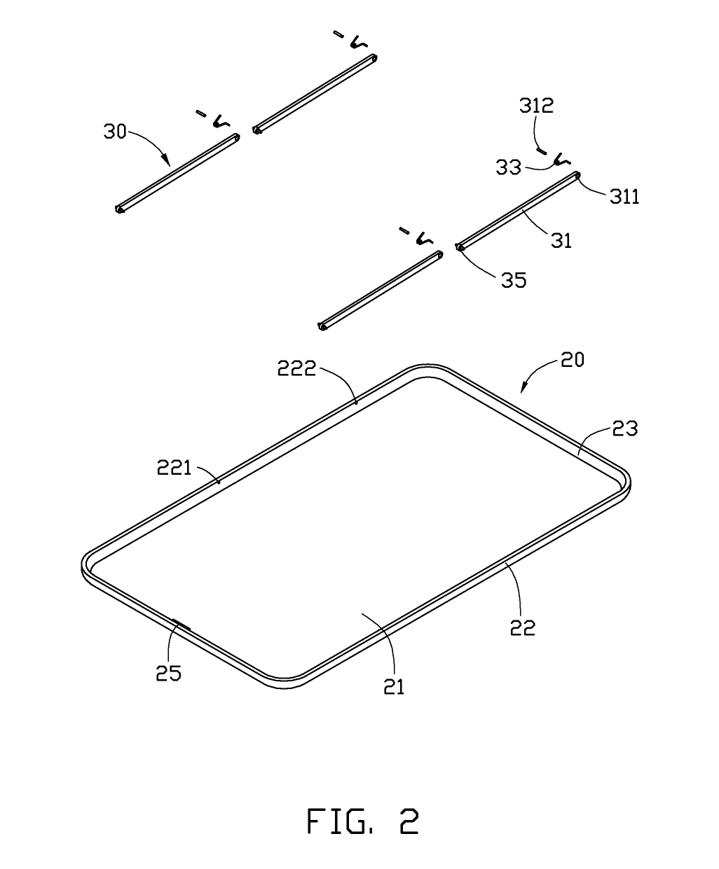

FIG. 2 shows the battery cover 20 from another direction. The battery cover 20 has a shape corresponding to the base body 10 and is configured to be attached to the base body 10. The battery cover 20 includes a cover body 21, two sidewalls 22 and two end walls 23. The two sidewalls 22 and the two end walls 23 are connected to a peripheral edge of the cover body 21. Each sidewall 22 has a post hole 221 and a post hole 222. A clasp 25 extends from one of the two end walls 23 for latching with the hook 15 of the base body 10.

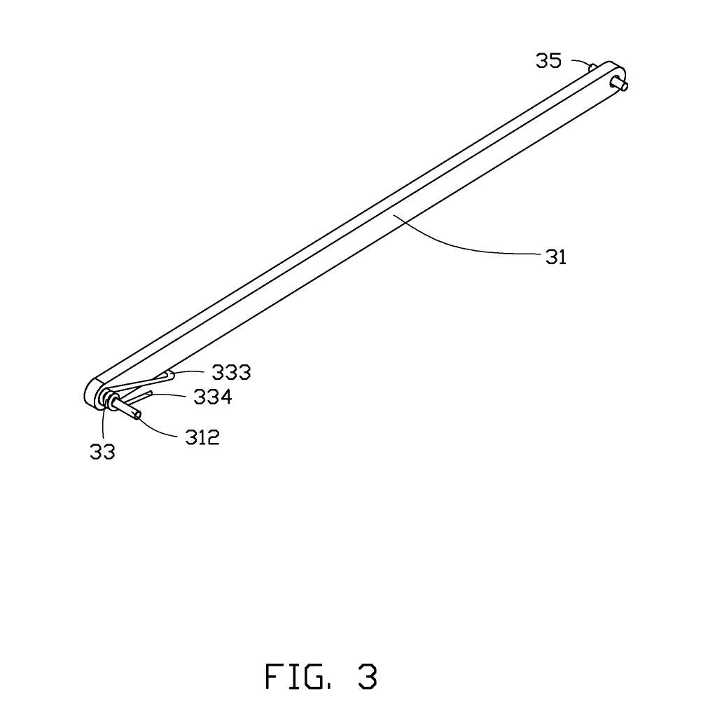

The four connecting modules 30 rotatably connect the battery cover 20 to the base body 10. Two of the four connecting modules 30 are received in one slot 13 and another two of the four connecting modules 30 are received in the other slot 13. FIG. 3 shows that each connecting module 30 includes a pivot arm 31 and a torsion spring 33. A first end of the pivot arm 31 has a shaft 312, and a second end of the pivot arm has a post 35. The shaft 312 is fixed to the shaft holes 131 or 132 and is rotatably connected to the first end of the pivot arm 31. The post 35 is fixed to the post hole 221 or 222 of the battery cover 20 and is rotatably connected to the second end of the pivot arm 31. The torsion spring 33 includes a first extending end 333 and a second extending end 334. The torsion spring 33 is fitted around the shaft 312 and is positioned between the pivot arm 31 and the slot 13. The first extending end 333 abuts against one side of the pivot arm 31, and the second extending end 334 abuts against the inner wall of the slot 13. The torsion spring 33 can provide a torsion force to rotate the pivot arm 31 relative to the base body 10.

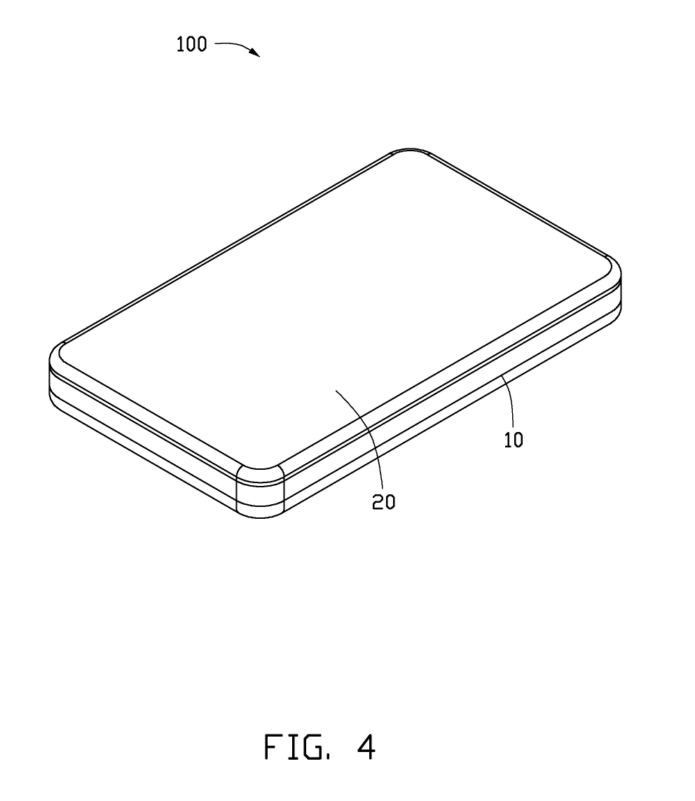

During assembly of the battery cover assembly, FIG. 4 shows that each torsion spring 33 is fitted around the shaft 312 of each pivot arm 31. Then, the shaft 312 of the pivot arm 31 of one connecting module 30 is rotatably connected to the shaft hole 131, and the post 35 of the pivot arm 31 of one connecting module 30 is rotatably connected to the post hole 221. The shaft 312 of the pivot arm 31 of another connecting module 30 is rotatably connected to the shaft hole 132, and the post 35 of the pivot arm 31 of another connecting module 30 is rotatably connected to the post hole 222. Thus, the two connecting modules 30 are assembled at one side of the battery cover 20 and the base body 10. The assembly process of the other two connecting modules 30 are similar, and herein are not detailed. The clasp 25 of the battery cover 20 is latched to the hook 15. Thus, the battery cover 20 is assembled in the base body 10. In a closed state, the battery cover 20 covers the base body 10. The torsion spring 33 has a predetermined torsion force to rotate the battery cover 20.

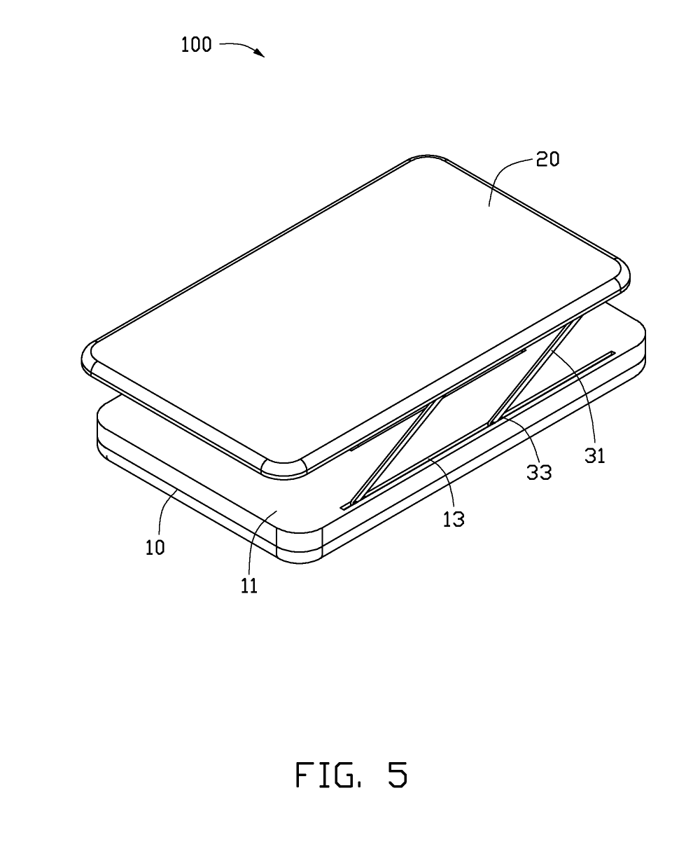

FIG. 5 shows that when the battery cover 20 is to be opened, the battery cover 20 is pushed with an external force to move toward the clasp 25 until the clasp 25 can then be separated from the hook 15. Under the force of the torsion springs 33, the pivot arms 31 rotate out of the slots 13 to allow the battery cover 30 to be rotated and moved relative to the base body 10. The battery cover 20 is moved away from one side of the base body 10. The battery 40 can then be removed.

As described above, the exemplary embodiment provides a battery cover assembly for portable electronic devices, such as mobile phones. The battery cover of the battery cover assembly can be easily opened and more user-friendly.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

1. A battery cover assembly for a portable electronic device, the battery cover assembly comprising:
a base body defining two opposite slots at opposite sides and having a hook at one end;
a battery cover having a clasp; and
four connecting modules received in the slots and rotatably attached to the base body and the battery cover, each connecting module comprising a pivot arm and a torsion spring, the torsion spring positioned on the pivot arm;
wherein one end of the pivot arms of each connecting module is rotatably connected to the base body, and another end of the pivots arm of each connecting module is rotatably connected to the battery cover, the torsion springs provide force to open the battery cover relative to the base body.

2. The battery cover assembly as claimed in claim 1, wherein one end of each pivot arm has a shaft, and another end of the pivot arm has a post, the torsion spring is fitted around the shaft.

3. The battery cover assembly as claimed in claim 2, wherein opposite inner walls of each slot have two first shaft holes at one end and two second shaft holes at a middle thereof, the battery cover has a first post hole and a second post hole at one side, the shaft of one connecting module is rotatably connected to the first shaft holes, and the post of one connecting module is rotatably connected to the first post hole, the shaft of the pivot arm of another connecting module is rotatably connected to the second shaft holes, and the post of the pivot arm of another connecting module is rotatably connected to the second post hole.

4. A portable electronic device comprising:
a base body defining two opposite slots and having a hook;
a battery cover having a clasp engaging with the hook; and
four connecting modules received in the slots and rotatably attached to the base body and the battery cover, each connecting module comprising a pivot arm and a torsion spring, the pivot arm having a first end and a second end, the torsion spring positioned on the first end;
wherein the first ends of the pivot arms of each connecting module are rotatably connected to the base body, and the second ends of the pivots arm of each connecting module are rotatably connected to the battery cover, the torsion springs provide force to open the battery cover relative to the base body.

5. The portable electronic device as claimed in claim 4, wherein the first end of each pivot arm has a shaft, and the second end of the pivot arm has a post, the torsion spring is fitted around the shaft.

6. The portable electronic device as claimed in claim 5, wherein opposite inner walls of each slot have two first shaft holes at one end and two second shaft holes at a middle thereof, the battery cover has a first post hole and a second post hole at one side, the first post of one connecting module is rotatably connected to the first shaft holes, and the second post of one connecting module is rotatably connected to the first post hole, the first post of the pivot arm of another connecting module is rotatably connected to the second shaft hole, and the second post of the pivot arm of another connecting module is rotatably connected to the second post hole.

7. The portable electronic device as claimed in claim 5, wherein the torsion spring includes a first extending end and a second extending end, the torsion spring is fitted around the shaft and is positioned between the pivot arm and the slot, the first extending end abuts against one side of the pivot arm, and the second extending end abuts against the inner wall of the slot.
